(19) United States
(12) Patent Application Publication
(10) Pub. No.: US 2004/0044531 A1
(43) Pub. Date: Mar. 4, 2004

(54) Speech recognition system and method

(76) Inventors: Nikola Kirilov Kasabov, Mission Bay (NZ); Waleed Habib Abdulla, Mt. Eden (NZ)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/380,382

(22) PCT Filed: Sep. 17, 2001
(86) PCT No.: PCT/NZ01/00192

(30) Foreign Application Priority Data
Sep. 15, 2000 (NZ) 506981

(51) Int. Cl. G10L 15/00

(52) U.S. Cl. 704/256

(57) ABSTRACT

The invention provides a method of speech recognition comprising the steps of receiving a signal comprising one or more spoken words, extracting a spoken word from the signal using a Hidden Markov Model, passing the spoken word to a plurality of word models, one or more of the word models based on a Hidden Markov Model, determining the word model most likely to represent the spoken word, and outputting the word model representing the spoken word. The invention also provides a related speech recognition system and a speech recognition computer program.

### FIELD OF INVENTION

The invention relates to speech recognition system and method, particularly suitable where robustness to variant speech characteristics for example gender, accent, age and level of noise is required.

### BACKGROUND TO INVENTION

Automated speech recognition is a difficult problem, particularly in applications requiring speech recognition to be free from the constraints of different speaker genders, ages, accents, speaker vocabularies, level of noise and different environments.

Human speech generally comprises a sequence of single sounds or phones. Phonetically similar phones are grouped into phonemes which differentiate between utterances. One method of speech recognition involves building a Hidden Markov Model (HMM) for each word in the expected vocabulary. The various parts of words in the expected vocabulary are represented as states in a left-right HMM .

Methods of implementing and training such HMMs for speech recognition are described in W. H. Abdulla and N. K. Kasabov, “The Concepts of Hidden Markov Model in Speech Recognition”, Technical Report TR99/09, University of Otago, July 1999; W. H. Abdulla and N. K. Kasabov, “Two Pass Hidden Markov Model for Speech Recognition Systems”, Paper #175, Proceedings of the ICICS'99, Singapore, December 1999; and L. R. Rabiner, “A Tutorial on Hidden Markov Models and Selected Applications in Speech Recognition”, Proceedings of the IEEE, Vol. 77, No. 2, pp. 257-286, February 1989.

### SUMMARY OF INVENTION

In broad terms in one form the invention comprises a method of speech recognition comprising the steps of receiving a signal comprising one or more spoken words; extracting a spoken word from the signal using a Hidden Markov Model; passing the spoken word to a plurality of word models, one or more of the word models based on a Hidden Markov Model comprising one or more states, each state including one or more word observations; determining the word model most likely to represent the spoken word; and outputting the word model representing the spoken word.

In broad terms in another form the invention comprises a speech recognition system comprising a receiver configured to receive a signal comprising one or more spoken words; an extractor configured to extract one or more spoken words from the signal using a Hidden Markov Model; a plurality of word models to which the spoken word is passed, one or more of the word models based on a Hidden Markov Model comprising one or more states, each state including one or more word observations; a probability calculator configured to determine the word model most likely to represent the spoken word; and an output device configured to output the word model representing the spoken word.

In broad terms in another form the invention comprises a speech recognition computer program comprising a receiver module configured to receive a signal comprising one or more spoken words; an extractor module configured to extract one or more spoken words from the signal using a Hidden Markov Model; a plurality of word models stored in a memory to which the spoken word is passed, one or more of the word models based on a Hidden Markov Model comprising one or more states, each state including one or more word observations; a probability calculator configured to determine the word model most likely to represent the spoken word; and an output module configured to output the word model representing the spoken word.

In broad terms in yet another form the invention comprises a method of initialising a word model for speech recognition comprising the steps of extracting one or more versions of a spoken word from one or more signals; segmenting the spoken word into one or more states, each state including one or more word observations; and calculating a probability function to represent the word model based on the states and the word observations.

### BRIEF DESCRIPTION OF THE FIGURES

Preferred forms of the method and system of speech recognition will now be described with reference to the accompanying figures in which:

FIG. 1 is a schematic view of the preferred system;

FIG. 2 is a further schematic view of the system of FIG. 1;

FIG. 3 is the topology of the underlying Markov chain of the models;

FIGS. 4A and 4B show a preferred method for training the models of FIG. 3; and

FIG. 5 shows a preferred method of denoising a speech signal.

### DETAILED DESCRIPTION OF PREFERRED FORMS

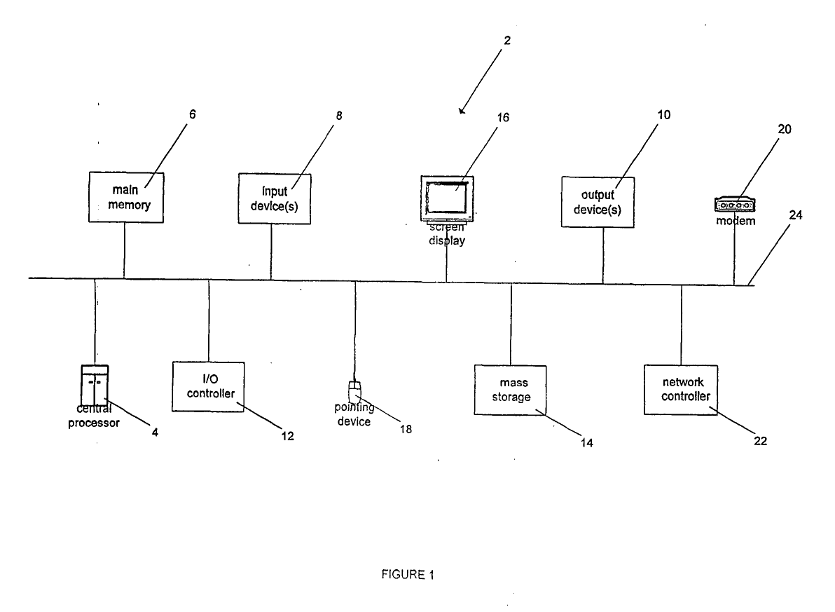

Referring to FIG. 1, the preferred system 2 comprises a data processor 4 interfaced to a main memory 6, the processor 4 and the memory 6 operating under the control of appropriate operating and application software or hardware. The processor 4 is interfaced to one or more input devices 8 and one or more output devices 10 with an I/O controller 12. The system 2 may further include suitable mass storage devices 14, for example floppy, hard disk or CD Rom drives or DVD apparatus, a screen display 16, a pointing device 18, a modem 20 and/or network controller 22. The various components could be connected via a system bus 24.

The preferred system is configured for use in speech recognition and is also configured to be trained on model speech signals. The input devices 8 could comprise a microphone and/or a further storage device in which audio signals or representations of audio signals are stored. Output devices 10 could comprise a printer for displaying the speech or language processed by the system, and/or a suitable speaker for generating sound. Speech or language could also be displayed on display device 16.

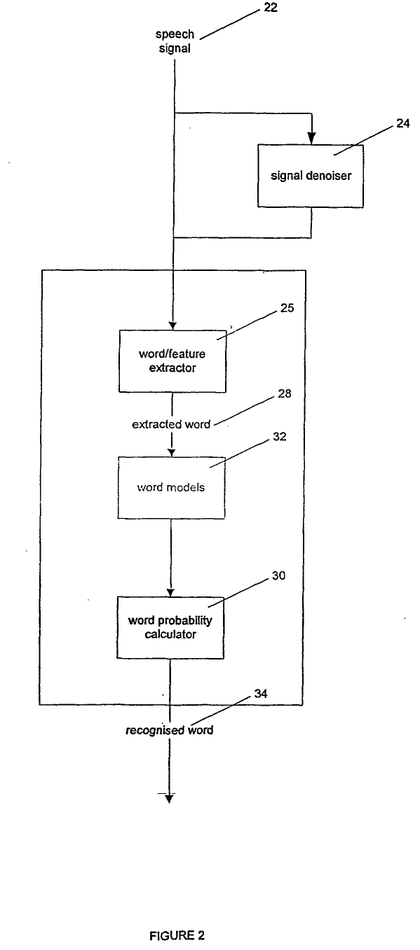

FIG. 2 illustrates the computer implemented aspects of the system indicated at 20 stored in memory 6 and arranged to operate with processor 4. A signal 22 is input into the system through one or more of the input devices 8. The preferred signal 20 comprises one or more spoken words from one or more speakers of differing genders, ages and/or accents and could further comprise background noise.

Where the signal 22 comprises a high proportion of static or background noise, the speech signal could optionally be processed by signal denoiser 24 before being input to the system 20. The signal denoiser could comprise a software module installed and operating on a memory, or could comprise a specific hardware device. The preferred signal denoiser 24 uses a wavelet technique both to reduce the dynamic behaviour of the speech signal and to remove unwanted background noise or static. The signal denoiser may, for example, decompose the signal 22 into low frequency and high frequency coefficients and then set all high frequency coefficients below a threshold level to zero followed by reconstruction of the decomposed signal based on the low frequency coefficients and the threshold high frequency coefficients. The signal denoiser 24 is further described below.

The preferred system may further comprise a combination word and feature extractor 25, a 3 state HMM for speech/background discrimination also arranged to extract one or more spoken words from the signal 22 by discriminating the speech from the background environment in the signal 22. The extractor 25 is preferably trained on a data set comprising words from different spoken entities in different background environments and normally selected in the range of 50 to 100 words. The extractor 25 is further described below. It could comprise a software module installed and operating on a memory, or could comprise a specific hardware device.

The extracted word or series of extracted words indicated at 28 is then passed to a word probability calculator 30 interfaced to one or more word models 32 stored in a memory. The system 20 preferably comprises a separate word model 32 for each word requiring recognition by the system. Each word model calculates a certain likelihood that the extracted word 28 passed to it is the word represented by the word model.

The probability calculator 30 assesses the respective likelihoods calculated by the word model 30. A decision maker forming part of the probability calculator determines the word model most likely to represent the extracted word. The model that scores maximum log likelihood log[P(O/λ)] represents the submitted input, where P(O/λ) is the probability of observation O given a model λ. The duration factor is incorporated through an efficient formula which results in improved performance. During recognition, the states' duration are calculated from the backtracking procedure using the Viterbi Algorithm. The log likelihood value is incremented by the log of the duration probability value as follows:

$$log [ \hat{P} ( q , O \vert λ ) ] = log [ P ( q , O \vert λ ) ] + η ( length ( O ) {\sum }_{j = 1}^{N} log [ {p}_{j} ( {τ}_{j} ) ]$$

where η is a scaling factor and τⱼ is the normalised duration of being in state j as detected by the Viterbi algorithm.

The recognised word indicated at 34 is then output by the system through output device(s) 10. The probability calculator could comprise a software module installed and operating on a memory, or could comprise a specific hardware device.

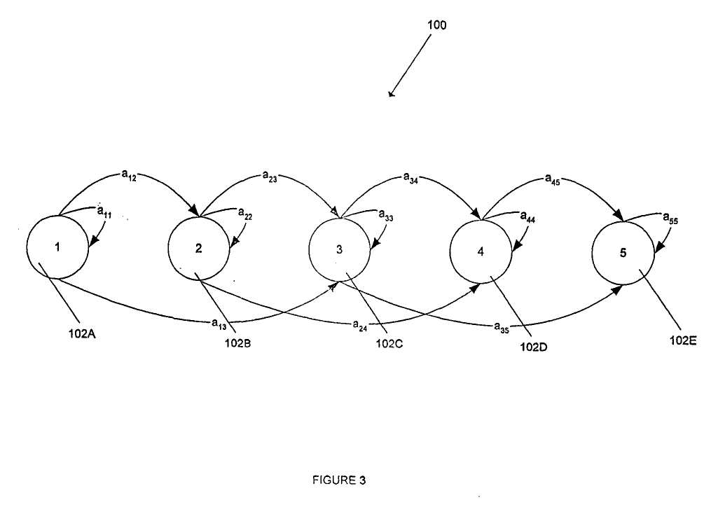

The preferred word model 32 is based on a nine state Continuous Density Hidden Markov Model which is described with reference to FIG. 3. Human speech generally comprises a sequence of single sounds or phones. Each word is preferably segmented uniformly into N states. Speech is produced by the slow movements of articulatory organs. The speech articulators taking up a sequence of different positions produce a stream of sounds forming the speech signal. Each articulatory position in a spoken word, for example, could be represented by a state of different and varying duration.

FIG. 3 shows a HMM 100 representing the underlying structure of the Markov chain. The model is shown as having five different states indicated at 102A, 102B, 102C, 102D and 102E respectively, modeled by a mixture of probability density functions, for example Gaussian mixture models. Five states are shown for the purpose of illustration, although there are preferably 9 states and 12 mixtures. The transition between different articulatory positions or states is represented as aᵢⱼ, the state transition probability. In other words, aᵢⱼ is the probability of being in state Sⱼ given state Sᵢ.

The model 100 is preferably constrained with a left-right topology to reduce the number of possible paths. When positioned at one state, the model assumes that the next state visited will be either the same state, the state one to the right, or the state two to the right. The left-right topology constraint may be defined as:

aᵢⱼ=0 for all j>i+2 and j<i

The same word could be pronounced differently depending on the individual speaker, the accent of the speaker, the language of the speaker and so on. The resulting model has one or more observations in each state, due to the variations in the pronunciation of each word. The training data set preferably comprises 50-100 utterances, from any language, of the same word taken from different speakers.

The model 100 is preferably implemented as a continuous Hidden Markov Model (CHMM) in which the probability density function (pdf) of certain observations O being in a state is considered to be of Gaussian Distribution.

Model parameter initialisation in accordance with the invention uses the following definitions:

[symbol] is the pdf distribution which is considered to be Gaussian in this example;

μᵢₘ is the mean of the m-th mixture in state i;

Uᵢₘ is the covariance of the m-th mixture in state i;

bᵢₘ(Oₜ) is the probability of being in state i with mixture m and given observation sequence Oₜ;

bᵢ(Oₜ) represents the probability of being in state i given observation sequence Oₜ;

cᵢₘ is the probability of being in state i with mixture m (gain coefficient);

Tᵢ is the total number of observations in state i;

Tᵢₘ is the total number of observations in state i with mixture m;.

N is the number of states;

M is the number of mixtures in each state.

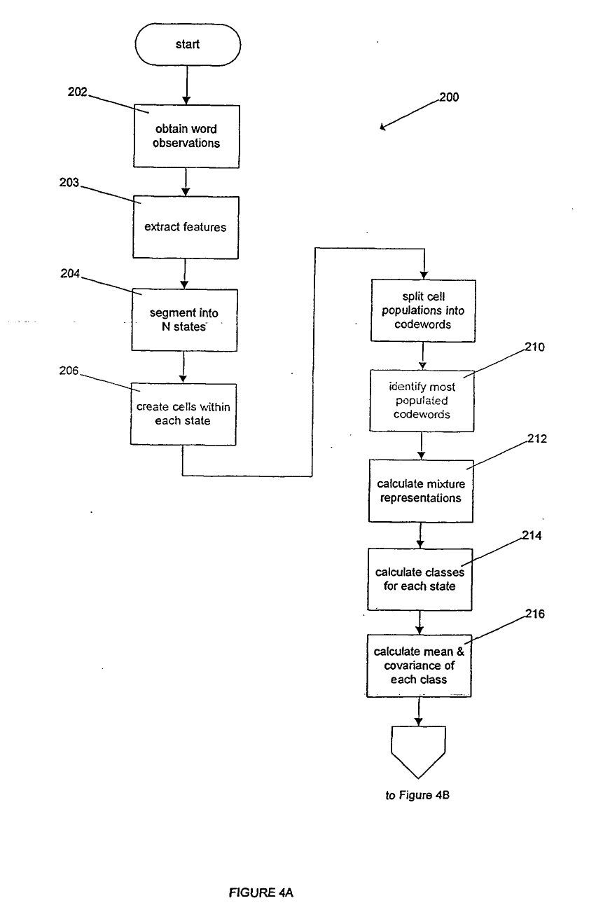

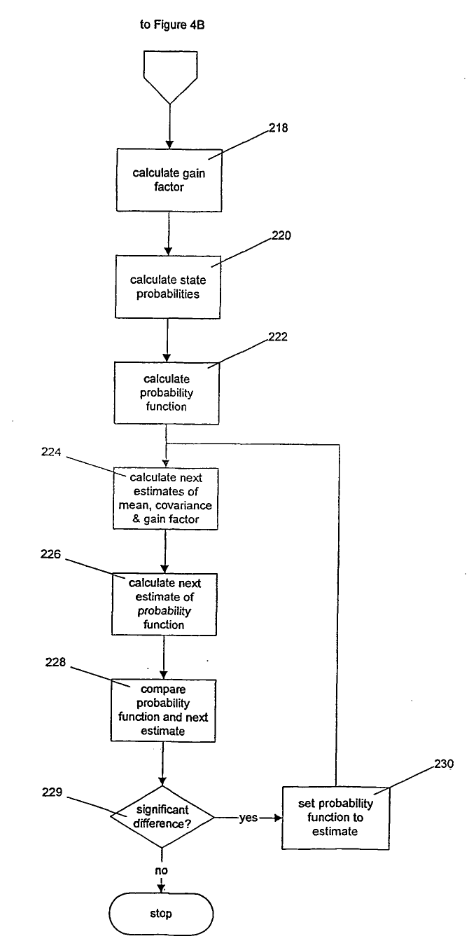

FIGS. 4A and 4B show a preferred method 200 for training each model to recognise a particular word. FIG. 4A shows those aspects of the method provided by the invention. The remaining aspects of the method shown in FIG. 4B are described in the prior art. Referring to FIG. 4A, the first step, as indicated at 202 is to obtain several versions or observations of individual words, for example the word “zero” spoken several times by different speakers.

As indicated at 203 the next step is to extract feature vectors which are composed of 28 mel scale coefficients (10 mels and one power+9 delta-mels and one delta-power+6 delta-delta mels and one delta-delta-power.

As shown at 204, each input word is segmented uniformly into N states. Preferably there are 9 states and 12 mixtures. Each speech frame is preferably of window length 23 ms taken every 9 ms. Some prior art techniques use a Viterbi algorithm to detect the states of each version of the training spoken word. These prior art techniques require a previously prepared model which is then optimised based on the training words. These previously prepared models could have been formed from just one speaker.

The present invention does not require a previously prepared model. At step 204, the invention creates a new model by segmenting each word into N states. We have found that the invention performs better than prior art systems, particularly when it is applied to varying and even unanticipated speakers, accents and languages, as new models are created from the training words.

After segmentation each state will contain several observations, each observation resulting from a different version or observation of individual words. As indicated at 206, each observation within each state is placed into a different cell. Each cell represents the population of a certain state derived from several observation sequences of the same word.

The resulting populations of each cell are represented by continuous vectors. It is however more useful to use a discrete observation symbol density rather than continuous vectors. Preferably a vector quantizer is arranged to map each continuous observation vector into a discrete code word index. In one form the invention could split the population into 128 code words, indicated at 208, identify the M most populated code words as indicated at 210, and calculate the M mixture representatives from the M most populated code words as indicated at 212.

As shown at 214, the population of each cell is then reclassified according to the M code words. In other words, the invention calculates Wₘ classes for each state from M mixtures.

Referring to step 216, the median of each class is then calculated and considered as the mean μᵢₘ. The median is a robust estimate of the centre of each class as it is less affected by outliers. The covariance, Uᵢₘ, is also calculated for each class.

The remaining steps of the model initialisation method are performed as described in the prior art. Referring to FIG. 4B, the gain factor Cᵢₘ is calculated as indicated at 218 as follows:

$${C}_{i m} = \frac{number of observations being in state i and mixture m}{total number of observations in state i}$$

Referring to step 220, the probability of being in state i with mixture m and given Oₜ (bᵢₘ(Oₜ)) and the probability of being in state i given observation sequence Oₜ (bᵢ(Oₜ)) are calculated as follows:

bᵢₘ(Oₜ)= [symbol] (Oₜ,μᵢₘ,Uᵢₘ)

$${b}_{i} ( {O}_{t} ) = {\sum }_{m = 1}^{M} {C}_{im} {b}_{i m} ( {O}_{t} )$$

The probability function of being in a mixture class Wᵢₘ given Oₜ in state i is represented as Φ(Wᵢₘ|Oₜ). Referring to step 222, it is calculated as follows:

$$Φ ( {W}_{i m} \vert {O}_{t} ) = {C}_{i m} \cdot \frac{{b}_{i m} ( {O}_{t} )}{{b}_{i} ( {O}_{t} )}$$

Using maximum likelihood, next estimates of mean, covariance and gain factor indicated at 224 are calculated as follows:

$${\hat{C}}_{i m} = \frac{1}{{T}_{i}} {\sum }_{t = 1}^{{T}_{i}} Φ ( {w}_{i m} \vert {O}_{t} )$$

Tᵢₘ=Tᵢ.ĉᵢₘ

$${\hat{μ}}_{i m} = \frac{1}{{T}_{i m}} {\sum }_{t = 1}^{{T}_{i}} Φ ( {w}_{i m} \vert {O}_{t} ) \cdot {O}_{t}$$

$${\hat{U}}_{i m} = \frac{1}{{T}_{i m}} {\sum }_{t = 1}^{T i} Φ ( {w}_{i m} \vert {O}_{t} ) \cdot ( {O}_{t} - {\hat{μ}}_{im} ) {( {O}_{t} - {\hat{μ}}_{i m} )}^{′}$$

$${\hat{b}}_{i m} ( {O}_{t} ) = {\sum }_{m = 1}^{M} {\hat{c}}_{i m} ( O ; {\hat{μ}}_{i m} , {\hat{U}}_{i m} ) , 1 \leq i \leq N$$

$${\hat{b}}_{i} ( {O}_{t} ) = {\sum }_{m = 1}^{M} {\hat{c}}_{i m} {\hat{b}}_{i m} ( {O}_{t} )$$

As indicated at step 226, the next estimate of Φ is calculated as follows:

$$\hat{Φ} ( {W}_{im} \vert {O}_{t} ) = \frac{{\hat{c}}_{i m} {\hat{b}}_{i m} ( {O}_{t} )}{{\sum }_{n = 1}^{M} {\hat{c}}_{i n} {\hat{b}}_{i n} ( {O}_{t} )}$$

Referring to step 228, if |Φ(Wᵢₘ|Oₜ)−\hat{Φ}(Wᵢₘ|Oₜ)|≦ε, where ε is a small threshold, then there is no significant difference between the actual and estimated rates and the model is considered adequately trained.

On the other hand, where there is a significant difference as shown at 229, the value of Φ(Wₜₘ|Oₜ) is set to the predicted value \hat{Φ}(Wᵢₘ|Oₜ) as indicated at 230 and the next estimates of mean, covariance and gain factor are recalculated.

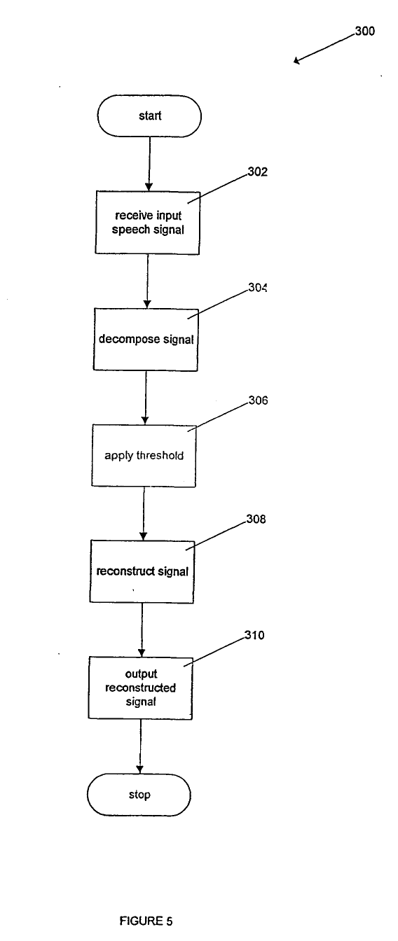

Referring to FIG. 2, the speech signal could optionally be processed by signal denoiser 24 before being input to the system. FIG. 5 illustrates a flow diagram of the preferred denoising method 300. As indicated at 302, an input speech signal is received by the input device(s) 8.

As shown at 304, the signal is decomposed into high scale low frequency coefficients or approximations and low scale high frequency coefficients or details. Decomposition is preferably performed by a wavelet, for example a symlet of form SYM4 which is decomposed up to level 8. This preferred wavelet is a modification of the Daubechies family of wavelets. The advantage of this form of wavelet is that it has more symmetry than other wavelets and has greater simplicity.

The input signal is preferably decomposed into approximations and details coefficients in a tree of depth 8. Preferably this decomposition may be repeated for more than one level and is preferably performed up to level 8.

The next stage in denoising the signal, as indicated at 306, is to apply an appropriate threshold to the decomposed signal. The purpose of thresholding is to remove small details from the input signal without substantially affecting the main features of the signal. All details coefficients below a certain threshold level are set to zero.

A fixed form thresholding level is preferably selected for each decomposition level from 1 to 8 and applied to the details coefficients to mute the noise. The threshold level could be calculated using any one of a number of known techniques or suitable functions depending on the type of noise present in the speech signal. One such technique is the “soft thresholding” technique which follows the following sinusoidal function:

$$y = \{ \begin{matrix}sgn ( x ) ( \vert x \vert - Δ ) for \vert x \vert > Δ \\ 0 for \vert x \vert \leq Δ\end{matrix} \}$$

where y is the denoised signal and x is the noisy input signal.

As indicated at 308, the signal is then reconstructed. Preferably the signal is reconstructed based on the original approximation coefficients of level 8 and the detail coefficients of levels 1 to 8 which have been modified by the thresholding described above. The resulting reconstructed signal is substantially free from noise, this noise having been removed by thresholding.

As indicated at 310, the reconstructed denoised signal is then output to the speech recognition system. The benefit of denoising is that of reducing background noise and dynamic behaviour in a speech signal. Such noise can be annoying in speaker to speaker conversation in wireless communications. Furthermore, in the field of automated speech recognition, the presence of background noise or static in a speech signal may prevent a speech recognition system correctly determining the beginning and end of spoken words.

Referring to FIG. 2, the speech signal could optionally be processed by a word extractor 26 arranged to extract one or more spoken words from the speech signal. The word extractor is preferably a computer implemented speech/background discrimination model (SBDM) based on a left-right continuous density Hidden Markov Model (CDHMM) described above having three states representing presilence, speech and postsilence respectively.

Unimodal data modelling is used in the parameter estimation. The observations are Mel scale coefficients of the speech signal frames with only 13 coefficients (12 Mels plus one power coefficient). The dynamic delta coefficients are preferably omitted to make the model insensitive to the dynamic behaviour of the signal and this gives more stable background detection. The speech frames for building the model are preferably of length 23 ms taken each 9 ms.

The invention provides a method and system of speech recognition which is particularly suitable where robustness to variant speech characteristics caused by for example gender, accent, age and different types of noise is required. The possible fields of application of the invention are in systems which use speech recognition to execute commands, wheelchair control, vehicles which respond to driver enquiries such as asking the driver about oil level, engine temperature or any other meter reading, interactive games which use speech commands, elevator control, domestic and industrial appliances arranged to be controlled by voice, and communication apparatus such as cellular phones.

The foregoing describes the invention including preferred forms thereof. Alterations and modifications as will be obvious to those skilled in the art are intended to be incorporated within the scope hereof, as defined by the accompanying claims.

1. A method of speech recognition comprising the steps of:
receiving a signal comprising one or more spoken words;
extracting a spoken word from the signal using a Hidden Markov Model;
passing the spoken word to a plurality of word models, one or more of the word models based on a Hidden Markov Model comprising one or more states, each state including one or more word observations;
determining the word model most likely to represent the spoken word; and
outputting the word model representing the spoken word.

2. A method as claimed in claim 1 wherein the step of extracting the spoken word from the signal uses a 3-state continuous density Hidden Markov Model.

3. A method as claimed in claim 1 or claim 2 wherein one or more of the word models is based on a 9-state continuous density Hidden Markov Model.

4. A method as claimed in claim 3 wherein the 9-state continuous density Hidden Markov model includes 12 mixtures.

5. A method as claimed in claim 4 wherein each of the 12 mixtures comprise a Gaussian probability distribution function.

6. A method as claimed in any one of the preceding claims, further comprising the step of denoising the speech signal.

7. A method as claimed in claim 6 wherein the step of denoising the speech signal further comprises the steps of:
decomposing the signal into low frequency and high frequency coefficients;
calculating modified high frequency coefficients by setting each high frequency coefficient below a threshold level to zero; and
reconstructing the decomposed signal based on the low frequency coefficients and the modified high frequency coefficients.

8. A method as claimed in claim 7 wherein the step of decomposing the signal is performed by a wavelet.

9. A method as claimed in claim 7 or claim 8 wherein the signal is decomposed up to level 8.

10. A method as claimed in any one of claims 7 to 9 further comprising the step of calculating the threshold level using a sinusoidal function.

11. A speech recognition system comprising:
a receiver configured to receive a signal comprising one or more spoken words;
an extractor configured to extract one or more spoken words from the signal using a Hidden Markov Model;
a plurality of word models to which the spoken word is passed, one or more of the word models based on a Hidden Markov Model comprising one or more states, each state including one or more word observations;
a probability calculator configured to determine the word model most likely to represent the spoken word; and
an output device configured to output the word model representing the spoken word.

12. A speech recognition system as claimed in claim 11 wherein the extractor is based on a 3-state continuous density Hidden Markov Model.

13. A speech recognition system as claimed in claim 11 or claim 12 wherein one or more of the word models is based on a 9-state continuous density Hidden Markov Model.

14. A speech recognition system as claimed in claim 13 wherein the 9-state continuous density Hidden Markov Model includes 12 mixtures.

15. A speech recognition system as claimed in claim 14 wherein each of the 12 mixtures comprise a Gaussian probability distribution function.

16. A speech recognition system as claimed in any one of claims 11 to 15 further comprising a speech signal denoiser.

17. A speech recognition system as claimed in claim 16 wherein the signal denoiser is configured to decompose the signal into low frequency and high frequency coefficients, calculate modified high frequency coefficients by setting each high frequency coefficient below a threshold level to zero, and reconstruct the decomposed signal based on the low frequency coefficients and the modified high frequency coefficients.

18. A speech recognition system as claimed in claim 17 wherein the decomposition of the signal is performed by a wavelet.

19. A speech recognition system as claimed in claim 17 or claim 18 wherein the signal is decomposed up to level 8.

20. A speech recognition system as claimed in any one of claims 17 to 19 wherein the threshold level is calculated using a sinusoidal function.

21. A speech recognition computer program comprising:
a receiver module configured to receive a signal comprising one or more spoken words;
an extractor module configured to extract one or more spoken words from the signal using a Hidden Markov Model;
a plurality of word models stored in a memory to which the spoken word is passed, one or more of the word models based on a Hidden Markov Model comprising one or more states, each state including one or more word observations;
a probability calculator configured to determine the word model most likely to represent the spoken word; and
an output module configured to output the word model representing the spoken word.

22. A speech recognition computer program as claimed in claim 21 wherein the extractor module is based on a 3-state continuous density Hidden Markov Model.

23. A speech recognition computer program as claimed in claim 21 or claim 22 wherein one or more of the word models is based on a 9-state continuous density Hidden Markov Model.

24. A speech recognition computer program as claimed in claim 23 wherein the 9-state continuous density Hidden Markov Model includes 12 mixtures.

25. A speech recognition computer program as claimed in claim 24 wherein each of the 12 mixtures comprise a Gaussian probability distribution function.

26. A speech recognition computer program as claimed in any one of claims 21 to 25 further comprising a speech signal denoiser module.

27. A speech recognition computer program as claimed in claim 26 wherein the signal denoiser module is configured to decompose the signal into low frequency and high frequency coefficients, calculate modified high frequency coefficients by setting each high frequency coefficient below a threshold level to zero, and reconstruct the decomposed signal based on the low frequency coefficients and the modified high frequency coefficients.

28. A speech recognition computer program as claimed in claim 27 wherein the decomposition of the signal is performed by a wavelet.

29. A speech recognition computer program as claimed in claim 27 or claim 28 wherein the signal is decomposed up to level 8.

30. A speech recognition computer program as claimed in any one of claims 27 to 29 wherein the threshold level is calculated using a sinusoidal function.

31. A speech recognition computer program as claimed in any one of claims 21 to 30 embodied on a computer-readable medium.

32. A method of initialising a word model for speech recognition comprising the steps of:
extracting one or more versions of a spoken word from one or more signals;
segmenting the spoken word into one or more states, each state including one or more word observations; and
calculating a probability function to represent the word model based on the states and the word observations.

33. A method of initialising a word model as claimed in claim 32 further comprising the step of creating one or more cells, representing respective word observations within each state.

34. A method of initialising a word model as claimed in claim 33 wherein the populations of the cells are represented by continuous vectors, the method further comprising the step of mapping continuous observation vectors into discrete code word indexes.

35. A method of initialising a word model as claimed in claim 34 further comprising the step of creating one or more classes representing respective states.

36. A method of initialising a word model as claimed in claim 35 further comprising the step of calculating the median and/or covariance for one or more of the classes.
